(19) United States
(12) Patent Application Publication
(10) Pub. No.: US 2015/0370599 A1
(43) Pub. Date: Dec. 24, 2015

(54) PROCESSING TASKS IN A DISTRIBUTED SYSTEM

(71) Applicant: Alibaba Group Holding Limited, George Town (KY)

(72) Inventors: Jianming Jiang, Hangzhou (CN); Dong Cheng, Hangzhou (CN); Xiaofen Yang, Hangzhou (CN)

(21) Appl. No.: 14/745,214

(22) Filed: Jun. 19, 2015

(30) Foreign Application Priority Data
Jun. 23, 2014 (CN) 201410283561.7

(51) Int. Cl. G06F 9/48

(52) U.S. Cl. CPC G06F 9/485; G06F 9/4881

(57) ABSTRACT

Embodiments of the present application relate to a method, apparatus, and system for processing a task in a distributed system. The method includes, in response to being triggered to start a task and before processing the task, determining, by a task processor in a distributed system of a plurality of task processors, a vital status of the task. In the event that the vital status of the task is set to alive, determining not to process the task, and in the event that the vital status of the task is set to dead, updating the vital status of the task so as to be set to alive, processing the task, and in response to completing the processing of the task, updating the vital status of the task to dead.

### CROSS REFERENCE TO OTHER APPLICATIONS

This application claims priority to People's Republic of China Patent Application No. 201410283561.7 entitled A METHOD AND A DEVICE FOR PROCESSING TASKS IN A DISTRIBUTED SYSTEM, filed Jun. 23, 2014 which is incorporated herein by reference for all purposes.

### FIELD OF THE INVENTION

The present application relates to a field of distributed computing. In particular, the present application relates to a method and a device for processing tasks in a distributed system.

### BACKGROUND OF THE INVENTION

Distributed service frameworks for providing various kinds of services are becoming increasingly widespread, both in large-scale Internet applications and in enterprise-level architectures. For example, in a large-scale Internet application according to some related art, one application is generally divided into multiple services. Each service has a corresponding task. The task corresponding to each service can be processed by a service processor in a distributed system.

Generally, dependencies are likely to exist between the services within, or associated with, an application. The dependencies between the services of an application can be intricate and complex. The intricacies and complexities of the dependencies between services cause the risk that a first service is forcibly interrupted because of an abnormality arising from a second service on which the first service is dependent. In such a situation, abnormal handling is applied to the first service that was forcibly interrupted.

According to some related art, pre-interruption service data of the interrupted service is saved in a storage server. In the event that the re-processing of the task corresponding to the interrupted service is triggered, a task server (or task process) in the distributed system continues processing the task corresponding to the interrupted service according to (e.g., using) service data saved in the server. Accordingly, abnormal handling generally uses the service data that corresponds to the pre-interruption service data and that is stored in a storage server before interruption in order to continue processing the task corresponding to the interrupted handling. However, the related art generally requires personnel to perform manual operations via a back-end interface to trigger the re-processing of the task corresponding to the interrupted service. The complexities associated with the dependencies between services can carry over to the triggering of the re-processing of the corresponding tasks. For example, in the event of incorrect operation, multiple personnel repeatedly triggering re-processing of tasks corresponding to the same interrupted service will result in multiple task servers (or task processes) repeatedly processing the same task, with the result that the service data may fail to satisfy the idempotence requirement.

In summary, abnormal handling can require manual operation by experienced personnel and complex dependencies between services can lead to improper abnormal handling. Therefore, there is a need for a method, device, and system for providing more effective processing of tasks in a distributed system.

### BRIEF DESCRIPTION OF THE DRAWINGS

Various embodiments of the invention are disclosed in the following detailed description and the accompanying drawings.

In order to provide a clearer explanation of the technical schemes in the prior art or in embodiments of the present application, simple introductions are given below to the drawings which are needed for the embodiments or the prior art. Obviously, the drawings described below are merely some embodiments in the present application. Persons with ordinary skill in the art could, without expending creative effort, obtain other drawings on the basis of these drawings.

FIG. 1 schematically depicts an exemplary environment that can be implemented according to various embodiments of the present application.

FIG. 2 is a flowchart of a method for processing tasks in a distributed system according to various embodiments of the present application.

FIG. 3 is a flowchart of a method for processing tasks in a distributed system according to various embodiments of the present application.

FIG. 4 is a diagram of a method for processing tasks in a distributed system according to various embodiments of the present application.

FIG. 5 is a structural block diagram of a device for processing tasks in a distributed system according to various embodiments of the present application.

FIG. 6 is a structural block diagram of a device for processing tasks in a distributed system according to various embodiments of the present application.

FIG. 7 is a structural block diagram of a device for processing tasks in a distributed system according to various embodiments of the present application.

FIG. 8 is a structural block diagram of a device for processing tasks in a distributed system according to various embodiments of the present application.

FIG. 9 is a structural block diagram of a first determining module according to various embodiments of the present application.

FIG. 10 is a functional diagram of a computer system for processing tasks in a distributed system according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a terminal generally refers to a device used (e.g., by a user) within a network system and used to communicate with one or more servers. According to various embodiments of the present disclosure, a terminal may include communication functionality. For example, a terminal may be a smart phone, a tablet computer, a mobile phone, a video phone, an e-book reader, a desktop Personal Computer (PC), a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), or the like.

According to some embodiments of the present disclosure, a terminal includes a smart home appliance with communication functionality. A smart home appliance can be, for example, a television, a Digital Video Disk (DVD) player, an audio device, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, or the like.

According to various embodiments of the present disclosure, a terminal can be any combination of the foregoing terminals. In addition, it will be apparent to one having ordinary skill in the art that a terminal according to various embodiments of the present disclosure is not limited to the foregoing terminal.

Various embodiments of the present disclosure include a method, a device (e.g., a terminal), and system for processing tasks. Some embodiments of the present disclosure include a method, a device, and a system for processing tasks in a distributed system.

Some embodiments of the task processing system employ a vital status that provides an indication (e.g., to a task processor (or task process)) of whether a task is being processed by another task processor (or task process). As used herein, a task processor refers to a processor configured to invoke and execute certain task functions. A task processor can be implemented using a computer processor, a processor core, a virtual machine, or the like. The vital status can be a flag that includes a binary representation of the status of the task and is stored with the task. In some embodiments, the vital status includes an alive or a dead indication. In the event that a task processor (or task process) in a distributed system is processing a task, the vital status of the task is set as alive. For example, the task processor (or task process) can update the vital status corresponding to the task when the task processor (or task process) is processing the task (e.g., when the task processor or task process begins processing the task). In the event that another task processor (or task process) wants to process the task, the other task processor (or task process) can use the vital status as a basis for determining that the task is alive and will thereupon not process the task. In the event that the task processor (or task process) finishes processing the task, the vital status corresponding to the task will be marked as dead. For example, the task processor (or task process) can update the vital status corresponding to the task when the task processor (or task process) is done with processing the task (e.g., when the task processor or task process completes processing the task). In the event that another task processor (or task process) is ready to process the task, the other task processor (or task process) can use the vital status as a basis for determining that the task is dead and may thereupon process the task.

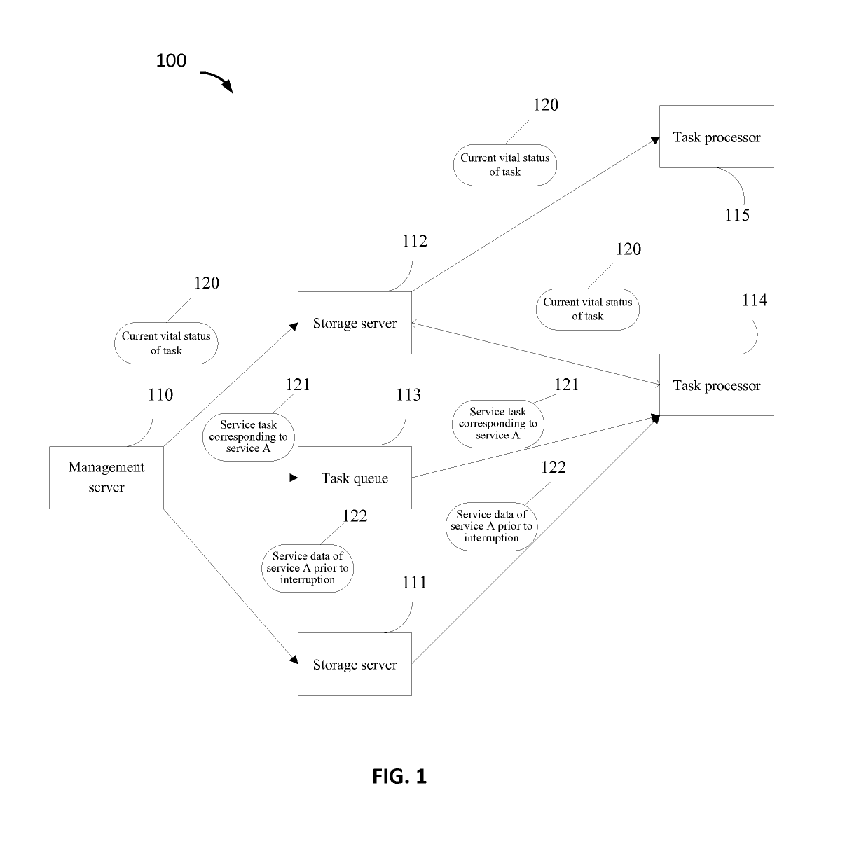

FIG. 1 schematically depicts an exemplary application scenario that can be implemented according to various embodiments of the present application.

Referring to FIG. 1, an application scenario 100 of processing a task (e.g., in a distributed system) is provided. The application scenario 100 can be implemented by various embodiments.

A distributed system can include a management server 110, a storage server 111, and a storage server 112. A task corresponding to service A 121 can be processed in the distributed system. As used herein, a task refers to an operation (or a set of operations) that can be invoked and executed. Examples of tasks include outputting an HTML page in response to an HTTP GET or HTTP POST request. During processing of the task 121, the processing of the task 121 can be forcibly interrupted.

When service A, which corresponds to service task 121 executing on management server 110 (e.g., a server that is in the distributed system and that is in communication with the management server 110), is forcibly interrupted (e.g., by I/O operations, exceptions, etc.), the management server 110 stores task 121 corresponding to service A in a task queue 113 and saves pre-interruption service data 122 associated with service A in a storage server 111. In addition, the current vital status 120 of task 121 is saved in the storage server 112. The task 121 is not being processed by any task processor (e.g., because the processing of task 121 was forcibly interrupted). Accordingly, the current vital status 120 of task 121 is marked as dead. The task 121 can be picked up (e.g., retrieved) from the task queue 113 for processing by at least one of the task processors. In the event that the task processor 114 is triggered to (e.g., caused to) extract task 121 from the task queue 113 and start task 121, the task processor 114 fetches the current vital status 120 of task 121 from the storage server 112. The task processor 114 can determine the status of the task 121 using the current vital status 120. In the event that the task processor 114 determines that the current vital status 120 indicates that the task 121 is dead, the task processor 114 updates the current vital status 120 of the task 121. For example, the task processor 114 sets the current vital status 120 of task 121 as alive. The task processor 114 can update the current vital status 120 of task 121 to indicate that the task 121 is alive to reflect that the task processor 114 is processing the task 121 (or is to process the task 121 after extracting the task 121 from the task queue 113). The task processor 114 extracts the pre-interruption service data 122 of service A from the storage server 112 and processes the task 121 based on the service data 122. The task processor 114 can extract the pre-interruption service data 122 of service A and process the task 121 after the task processor extracts the task 121 from the task queue 113 and updates (or sets) the current vital status 120 of task 121. If the task processor 115 is also triggered to (e.g., caused to) extract task 121 from the task queue 113 and start task 121, while the task processor 114 is processing task 121, the task processor 115 will fetch the current vital status 120 of task 121 from the storage server 112. Because the task processor 114 is processing the task 121 (and updated the current vital status 120 of task 121 to indicate that the task 121 is alive), the processor 115 determines that the current vital status 120 of the task 121 is set to alive. Therefore, the task processor 115 will not process task 121. In response to the task processor 114 finishing processing task 121, the task processor 114 updates the current vital status 120 of task 121. For example, the task processor 114 will update the current vital status 120 of task 121 so as to set the current vital status 120 as dead (e.g., to reflect that the task processor 114 is no longer processing the task 121). In the event that another task processor is subsequently triggered to (e.g., caused to) extract the task 121 from the task queue 113, the other task processor can determine that the task 121 can be processed by determining that the current vital status 120 of task 121 is set to dead.

In some embodiments, the management server 110 is implemented as a server. For example, the management server 110 can be a web server, an app server, or the like. The task processor 114 or the task processor 115 can be task processes executing on a server that is in the distributed system and that is in communication with the management server 110.

In various implementations, a task server is triggered to (e.g., caused to) extract a task from a task queue and start the task by an operator monitoring the operation of the tasks. For example, the task server is manually triggered to extract the task from the task queue and start the task.

In various implementations, a task server is triggered to (e.g., caused to) extract a task from a task queue and start the task by code that is executed (e.g., by the management server 110 or the task server). In the event that code is implemented to trigger a task server to extract a task and start the task, the code can automatically trigger the task server to extract the task from the task queue and start the task in response to a task failing.

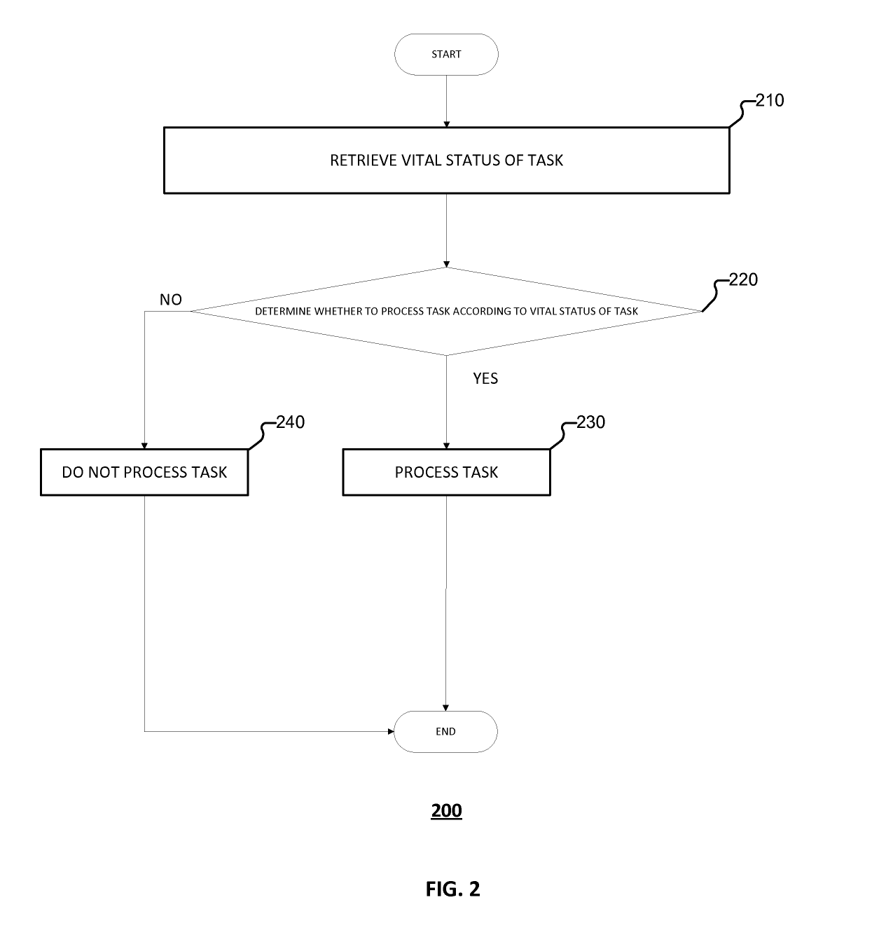

FIG. 2 is a flowchart of a method for processing tasks in a distributed system according to various embodiments of the present application.

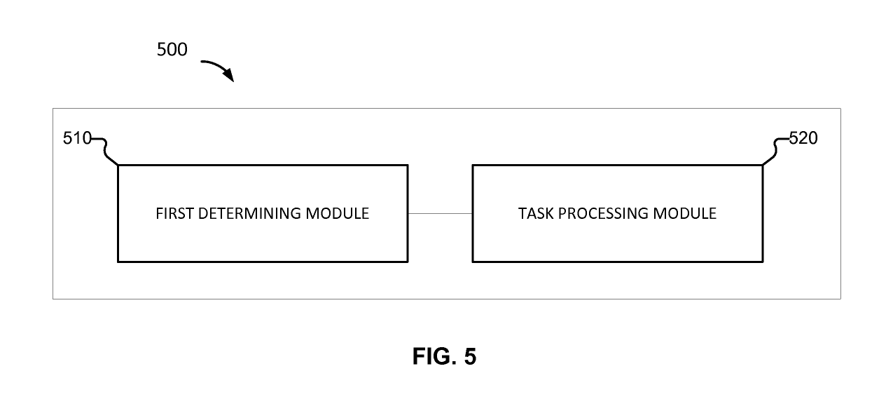

Referring to FIG. 2, a method 200 for processing tasks in a distributed system is provided. Method 200 can be implemented by device 500 of FIG. 5.

At 210, a vital status of a task is retrieved. In some embodiments, the vital status is an identifier (e.g., an indicator) that provides an indication of whether a task is being processed by another task processor (or task process). The vital status can be a flag that includes a binary representation of the status of the task. In some embodiments, the vital status includes an alive or a dead indication (e.g., 1 being live, 0 being dead). The vital status of a task can be retrieved from a storage device (e.g., a storage server). The storage device can store a database storing mappings of vital statuses to tasks. For example, each task can have a task name or a unique identifier with which a particular task can be distinguished from another task (e.g., another task stored in the task queue). A task processor (or task process) can retrieve the vital status of the task in response to the task processor (or task process) receiving an indication or instruction to process the task. For example, the task processor (or task process) can retrieve the vital status of the task in response to receiving an indication or instruction to process the task from a human operator (e.g., an IT personnel), or automatically according to a task processing schedule. The human operator can input the indication or instruction to process the task via an interface (e.g., an interface provided by a management server). The vital status of the task can be retrieved by searching the database storing the mappings of vital statuses to tasks for a vital status corresponding to a task name or a unique identifier associated with the task.

At 220, a determination is made as to whether to process the task according to the vital status of the task. The task processor (or task process) can analyze the vital status and determine whether to process the task according to the value of the vital status. For example, in the event that the vital status of the task is set to alive, which indicates that the task is already being processed by another task processor, the current task processor (or task process) will not process (e.g., not continue with processing) the task. As another example, in the event that the vital status of the task is set to dead, which indicates that the task is not being processed, the task processor (or task process) can proceed to process (e.g., continue with processing) the task.

At 230, the task is processed. In response to determining to process the task according to the vital status of the task, the task is processed. For example, in the event that the vital status of the task is set to dead, the task processor (or task process) can determine to process (e.g., continue with processing) the task. In responding to determining to process the task, the vital status of the task can be updated. For example, the vital status of the task can be updated to reflect that the task is being processed by a task processor (or task process). In some embodiments, the vital status of the task is set to alive. In response to completing processing of the task, the vital status of the task can be updated. For example, the vital status of the task can be updated to reflect that the task is not being processed by a task processor (or task process). In some embodiments, the vital status of the task is set to dead upon completion of the processing of the task.

At 240, the task is not processed. In response to determining not to process the task according to the vital status of the task, the task is not processed. Method 200 ends.

The task corresponds to a single task, or to multiple tasks of the same task type.

In some embodiments, one unique identifier is saved in the storage server for each type of task. For example, the database storing mappings of vital statuses to tasks using unique identifiers to identify tasks can use one unique identifier for each type of task. In some embodiments, a type of task can correspond to an HTTP get, an HTTP post, or the like. Other types of tasks are possible.

In the event that personnel trigger re-processing of a task corresponding to an interrupted service, the real time nature of the service processing is likely to be affected, because the personnel often cannot promptly carry out the triggering for the processing of the task. In relation to a service with higher real time requirements, any delay in the personnel triggering the processing of the task may be intolerable.

Accordingly, in some embodiments, a determination of whether the preset work cycle time has been reached is made before the task is caused to be processed (e.g., before the re-processing of the task is re-triggered). In the event that the preset work cycle time has been reached (e.g., according to a system timer configured to track the work cycle time), the task is automatically started. In the event that the preset work cycle time has not been reached, then the task is not started (and the determination of whether the preset work cycle time has been reached continues). For example, the determination of whether the preset work cycle time has been reached can include polling for an indication of an expiration of a timer associated with the preset work cycle time.

In some embodiments, various task processors (or task processes) do not start and process the tasks corresponding to various interrupted services in response to being triggered by personnel (e.g., in response to manual triggering by human operators), but rather the tasks corresponding to interrupted services are automatically started (e.g., triggered) at certain intervals, and thus the real time nature of the service processing is ensured.

The specific length of the work cycle is not limited. In some embodiments, the length of the work cycle can be decided by the service type. The length of the work cycle can be configured such that the higher the real-time processing requirement of a service, the shorter the length of the work cycle. Conversely, the length of the work cycle can be configured such that the lower the real-time processing requirement of a service, the longer the length of the work cycle. In some embodiments, the work cycles of various task processors (or task processes) can be synchronous with each other. For example, various types of tasks (e.g., an HTTP get and an HTTP post) can have the same work cycle. In some embodiments, the work cycles of various task processors (or task processes) can be asynchronous to avoid competition between processing of different tasks by the task processors (or task processes).

According to various embodiments of the present disclosure, in the event that one task processor (or task process) in a distributed system is processing a particular task, the vital status of the task is marked as alive. If, during the time when the particular task is being processed, another task processor (or task process) wants (e.g., is triggered) to process the particular task, the other task processor (or task process) can use the vital status as a basis for determining that the particular task is alive (e.g., that the particular task is being processed by a task processor) and will thereupon not process the particular task. When the task processor (or task process) finishes processing the processor task, the vital status of the particular task is set as dead. If another task processor (or task process) wants (e.g., is triggered) to process the particular task, the other processor (or task process) can use the vital status as a basis for determining that the particular task is dead (e.g., that the particular task is not being processed by a task processor) and may thereupon process the particular task. Various embodiments manage processing of a task such that multiple task servers (or task processes) will not repeat (or concurrent) processing of the same task and thus the idempotence of service data associated with the task is ensured.

If a task processor (or task process) suddenly experiences a fault (e.g., the task processor suddenly loses power), or the task suddenly breaks down while processing a task, the task processor (or task process) will not be able to promptly update the current vital status of the task. Consequently, the vital status associated with the task will continue to be set as alive despite the task processor having experienced the fault. In such a situation, other task processors (or processing processes) will not be able to continue processing the task (e.g., because the other task processors will assume that the task is being processed based on the vital status being set as alive). In some embodiments, after changing the vital status of the task from being set as dead to being set as alive, the lifetime of the task is updated at fixed intervals or fixed times. For example, any one of the multiple task processors is configured to update the lifetime of the task. In some embodiments, the lifetime of the task is updated at 230 of method 200 of FIG. 2.

In some embodiments, the lifetime of a particular task is the amount of time that that particular task is being processed by a task processor (e.g., the amount of time that has passed since the particular task processor picked the task up for processing). For example, the lifetime can indicate the amount of time that the task is continuously set as alive (e.g., in connection with the processing of the task by a particular task processor).

The lifetime of the task can be stored in association with the task name or task identifier. In some embodiments, the storage device (e.g., the storage server) that stores the task name of the task and the identifier of the vital status associated with the task also saves the lifetime of the task. In some embodiments, the lifetime of the task is updated in real time.

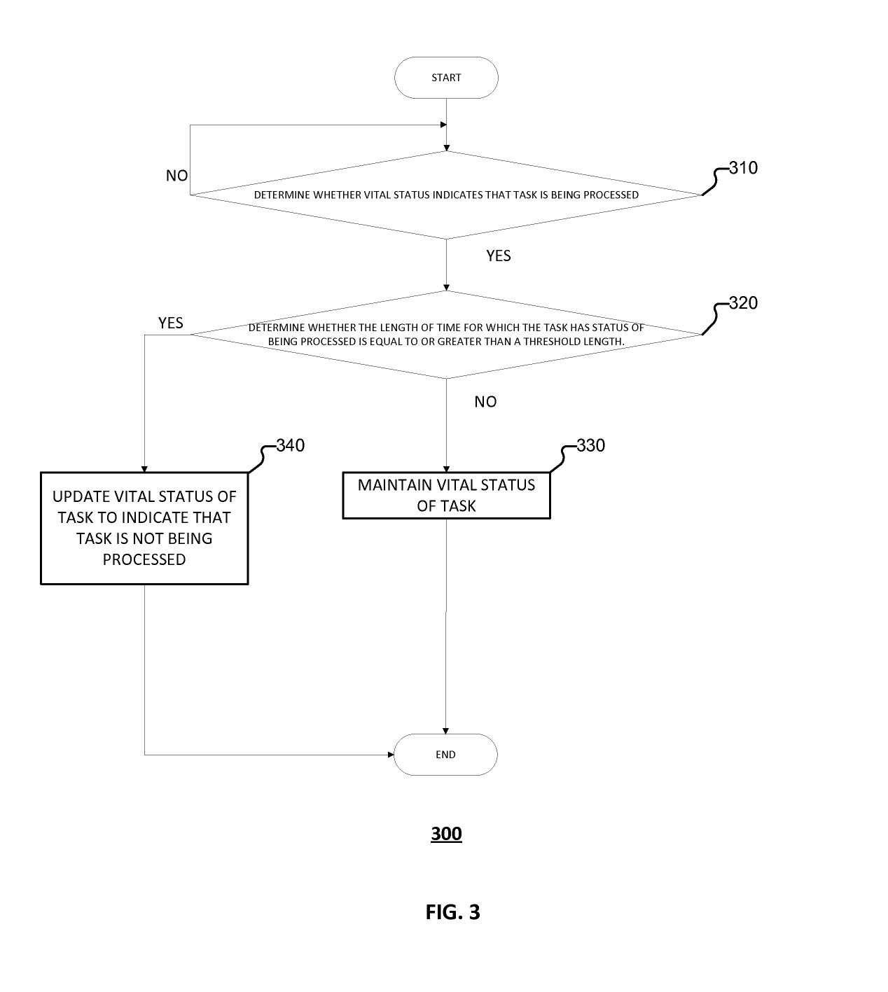

In the event that the storage server saves the lifetime of the task, any one or several of the task processors (task processes) in the distributed system can test the task at fixed times according to the lifetime of the task. In response to a task processor determining that the length of time that the task has been continually alive is greater than or equal to a preset threshold time length, the current vital status of the task is changed to dead. The preset threshold time length can be configurable by a user or a server according to user preferences or settings. In some embodiments, a task processor in a distributed system can test the task according to process 300 of FIG. 3.

In various implementations, testing a task includes inquiring (checking on) a status of a particular task. For example, testing a task can include sending a message to inquire a status of a particular task.

In some embodiments, after the vital status of the task is retrieved at 210, a determination can be made as to whether a preset cycle has been reached. The determination of whether the preset work cycle has been reached can be made in connection with 220 of method 200 or before 220 of method 200. In the event that the preset work cycle has been determined to have been reached, the determination of whether to process the task according to the vital status of the task of 220 can be made.

FIG. 3 is a flowchart of a method for processing tasks in a distributed system according to various embodiments of the present application.

Referring to FIG. 3, a process 300 for testing a task is provided. Process 300 can be implemented at the same time that method 200 of FIG. 2 is being performed. For example, process 300 can be implemented concurrently with execution (e.g., processing) of a task by a task processor. Process 300 can be implemented by a task processor (or task process). The task processor can be implemented in a server (e.g., a task server).

At 310, a determination of whether a vital status corresponding to a task indicates that the task is being processed. For example, the determination of whether the vital status corresponding to a task indicates that the task is being processed can include determining whether a vital status of a task is set to alive. The determination of whether the vital status corresponding to a task indicates that the task is being processed (e.g., that the vital status is set to alive) can be performed by a task processor. The task processor determining whether the vital status corresponding to a task indicates that the task is being processed can be any one of multiple task processors (or other processors) that are not processing the task.

In the event that the vital status indicates that the task is not being processed at 310, then the process 300 can poll for an indication that the task is being processed. For example, 310 can be repeated until the vital status is determined to indicate that the task is being processed.

In the event that the vital status indicates that the task is being processed at 310, at 320, a determination is made as to whether the length of time for which the task has a status of being processed is equal to or greater than a threshold length. For example, in the event that the vital status is set to alive, a determination is made as to whether the length of time for which the vital status is set to alive is equal to or greater than the threshold length. The task process can determine whether the length of time that the task has been continually set to alive is greater than or equal to the threshold length.

The threshold length can be configurable by a user or a server. In some embodiments, the threshold length can be configured or set according to the task type. In some embodiments, the threshold length is set to N times the maximum historical value of time spent executing the task, where N is a positive value greater than or equal to 1. The threshold length can be set to N times the maximum historical value of time spent executing tasks of the same task type as the task. Various embodiments can use other statistical measures of historical values relating to the processing of tasks to set the threshold length.

In the event that the length of time for which the task has a status of being processed is not equal to or greater than the threshold length at 320, at 330, the vital status indicating that the task is being processed is maintained. For example, if the vital status of the task is set to alive for a length of time less than the threshold length, the vital status is maintained as alive.

In contrast, in the event the length of time for which the task has a status of being processed is equal to or greater than the threshold length at 320, at 340, the vital status of the task is updated to indicate that the task is not being processed. For example, if the vital status of the task is set to alive for a length of time equal to or greater than the threshold length, the vital status is updated so as to be set to dead.

In some embodiments, in the event that a task processor (or task process) experiences a fault while processing a task and is unable to promptly update the current vital status of the task and the task remains in an alive status, other task processors (or processing processes) are able to normally continue processing the task. For example, despite the vital status continuing to indicate that a task is alive after a fault of a task processor that was processing the task, another task processor can process the task.

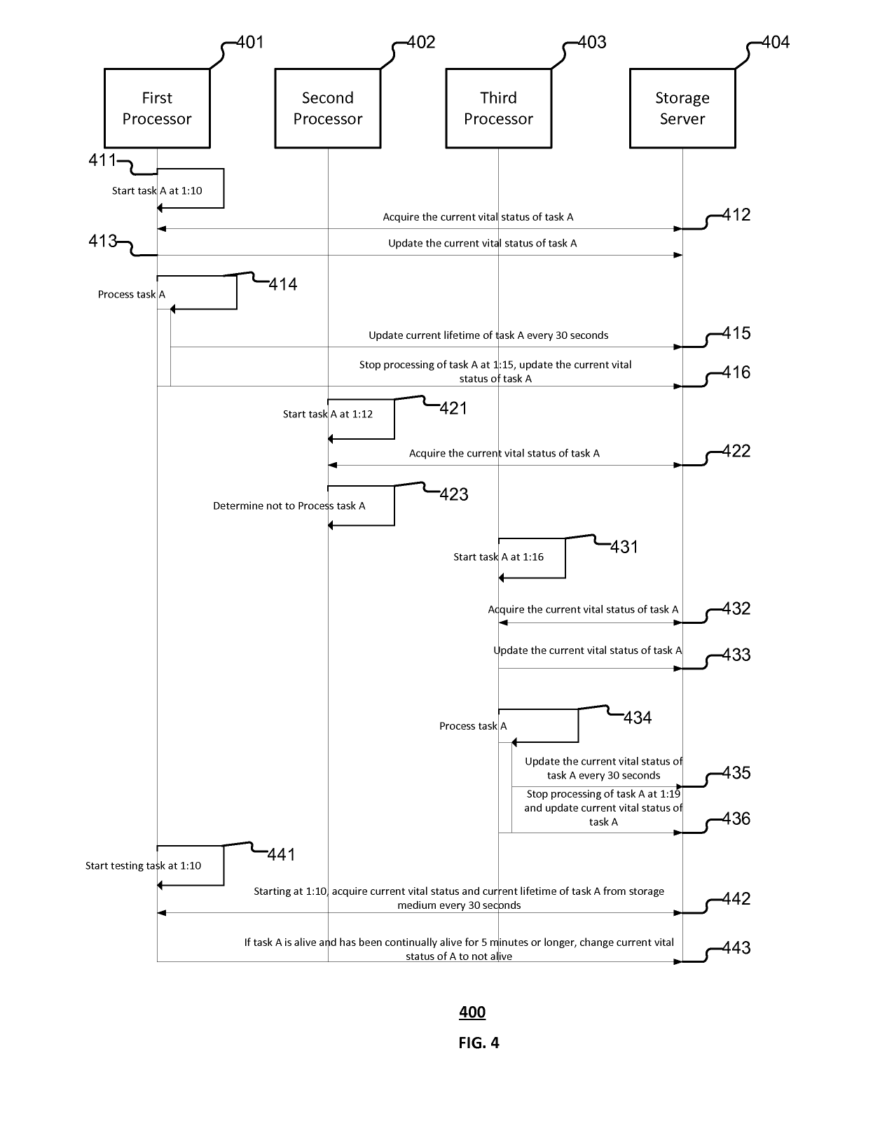

FIG. 4 is a diagram of a method for processing tasks in a distributed system according to various embodiments of the present application.

Referring to FIG. 4, a process 400 for processing tasks is provided. Process 400 can be implemented by a distributed system including a plurality of task processors (a first task processor 401, a second task processor 402, and a third task processor 403). The distributed system can also include a storage server 404.

Each of the first task processor 401, the second task processor 402, and the third task processor 403 can start a task every threshold period of time (e.g., five minutes), and a task processor (e.g., the first task processor 401) can perform a task test every test threshold period of time (e.g., five minutes).

At 411, first task processor 401 starts task A at 1:10. Task A can include all tasks corresponding to service type A. For example, task A can be a task set comprising multiple tasks of the service type A.

At 412, first task processor 401 acquires the vital status of task A from the storage server 404. The vital status is an identifier (e.g., an indicator) that provides an indication of whether a task is being processed by another task processor (or task process). The vital status can be a flag that includes a binary representation of the status of the task. In some embodiments, the vital status includes an alive or a dead indication.

The storage server 404 can store a database storing mappings of vital statuses to tasks. For example, each task can have a task name or a unique identifier with which a particular task can be distinguished by another task (e.g., another task stored in the task queue). A task processor (e.g., first task processor 401) can retrieve the vital status of the task in response to the task processor receiving an indication or instruction to process the task. For example, the task processor can retrieve the vital status of the task in response to receiving an indication or instruction to process the task from a human operator (e.g., an IT personnel), from a management server, or the like. The vital status of the task can be retrieved by searching the database storing the mappings of vital statuses to tasks for a vital status corresponding to a task name or a unique identifier associated with the task.

At 413, the first task processor 401 updates the vital status of the task A. For example, the first task processor 401 uses the vital status of task A as a basis for determining that task A is dead and thus updates the vital status of task A to being set as alive. The first task processor 401 determines to update the vital status of task A to set the status to alive because the vital status of task A at the time when the first task processor 401 retrieved (or acquired) the vital status of task A was set to dead (e.g., meaning that the task A was not being processed by another task processor). The update of the vital status is stored in the storage server 404.

At 414, first task processor 401 processes task A.

At 415, the first task processor 401 updates the lifetime of task A. The first task processor 401 can update the lifetime of task A while processing task A. The first task processor 401 can update the lifetime of task A in the storage server every 30 seconds. The time period between updates of the lifetime of task A can be configured by a user or server according to user or system preferences.

At 416, the first task processor 401 stops processing task A and the vital status of task A is updated. The first task processor 401 stops processing at 1:15. When the first task processor 401 stops processing task A because the processing is interrupted or because of a loss of power, the processing of task A has not been completed. The vital status of task A, which was set to alive while the first task processor 401 was processing task A, is updated so as to be set to dead. The update to the vital status of A is stored in the storage server 404. For example, the first task processor 401 sends an update to the vital status to the storage server 404.

At 421, the second task processor 402 starts task A at 1:12.

At 422, the second task processor 402 acquires the vital status of task A from the storage server 404.

At 423, the second task processor 402 determines whether to continue to process the task A according to the vital status of task A. For example, the second task processor 402 uses the vital status of task A as a basis for determining whether task A is alive. Because the task A is being processed by the first task processor 401 at 1:12, the vital status of task A indicates that task A is alive. Accordingly, the second task processor 402 does not process task A (e.g., the second task processor 402 determines to not continue with processing of task A).

At 431, the third task processor 403 starts task A at 1:16.

At 432, the third task processor 403 acquires the vital status of task A from the storage server 404.

At 433, the third task processor 403 determines whether to continue to process task A according to the vital status of task A. For example, the third task processor 403 uses the vital status of task A as a basis for determining whether task A is alive. Because the first task processor 401 stopped processing task A at 1:15, the vital status at the time that the third processor 403 starts processing task A is dead (e.g., the third processor started processing task A at 1:16). Accordingly, the third task processor 403 determines to process task A according to the vital status of task A. The third task processor 403 can further update the vital status of task A to set the vital status of task A to alive.

At 434, the third task processor 403 processes task A.

At 435, the third task processor 403 updates the lifetime of task A. The third task processor 403 can update the lifetime of task A while processing task A. The third task processor 403 can update the lifetime of task A in the storage server every 30 seconds.

At 436, the third task processor 403 completes processing of task A and the vital status of task A is updated. The third task processor 403 stops processing at 1:19. The vital status of task A, which was alive while the third task processor 403 was processing task A, is updated so as to be set as dead. The update to the vital status of A is stored in the storage server 404. For example, the third task processor 403 sends an update to the vital status to the storage server 404.

At 441, the first task processor 401 starts testing task A at 1:10. In various implementations, testing a task includes inquiring (checking on) a status of a particular task. For example, testing a task can include sending a message to inquire a status of a particular task. A task can be tested to ensure that the event that caused a task processor to stop processing a task (e.g., an interrupt, or a loss of power) is properly handled. In various implementations, the first task processor 401 can test the task A before starting to process task A.

At 442, the first task processor 401 acquires the vital status of task A and acquires the lifetime of task A. The first task processor 401 can start acquiring the vital status of task A and acquires the lifetime of task A at 1:10. The first task processor 401 acquires the vital status of task A and acquires the lifetime of task A from a storage server every 30 seconds. The time period between acquisition of the vital status of task A and the lifetime of task A can be configured by a user or server according to user or system preferences.

At 443, the first task processor 401 can update the vital status of task A. The first task processor 401 can update the vital status of task A in the event that the vital status of task A is set to alive for a length of time greater than or equal to a threshold length (e.g., five minutes). For example, if the first task processor 401 determines that task A is alive based on the vital status of task A, and determines that the vital status of task A has been continually alive for a length of time greater than or equal to five minutes based on the lifetime of task A, the first task processor 401 changes (e.g., updates) the vital status of task A in the storage server 404 to dead.

When one task processor (or task process) in a distributed system is processing a particular task, the vital status of the particular task will be marked as alive. If, at this time, other task processors (or task processes) are triggered (e.g., caused) to process the particular task, the other task processors can use the vital status as a basis for determining that the particular task is alive and will thereupon not process the particular task. When the task processor (or task process) finishes processing the particular task, the vital status of the particular task will be marked as dead. If, at this time, other task processors (or task processes) are triggered (e.g., caused) to process the particular task, the other processors can use the vital status as a basis for determining that the particular task is dead and may thereupon process the particular task. Accordingly, various embodiments ensure that multiple task processors (or task processes) will not repeat processing of the same task at a single time point and thus ensure the idempotence of service data.

Various embodiments ensure that, when a task processor (or a task process) suddenly experiences a fault while processing a task and is unable to promptly update the current vital status of the task such that the task remains in an alive status, other task processors (or processing processes) may still be able to normally continue processing of the task.

FIG. 5 is a structural block diagram of a device for processing tasks in a distributed system according to various embodiments of the present application.

Referring to FIG. 5, a device 500 for processing tasks is provided. Device 500 can be implemented in a distributed system comprising a plurality of task processors. Device 500 can implement method 200 of FIG. 2.

Device 500 includes a first determining module 510 and a task processing module 520.

The first determining module 510 is configured to determine the vital status of a task. The first determining module 510 can determine the vital status of the task after starting a task and before processing the task. In some embodiments, the first determining module 510 retrieves (or acquires) the vital status of the task from a storage device (e.g., a storage server). The vital status is an identifier (e.g., an indicator) that provides an indication of whether a task is being processed by another task processor (or task process). The vital status can be a flag that includes a binary representation of the status of the task. In some embodiments, the vital status includes an alive or a dead indication.

The task processing module 520 is configured to determine whether to process the task according to the vital status of the task. The task processing module 520 determines whether to process the task according to the value of the vital status (e.g., determined by the first determining module 510). For example, in the event that the vital status of the task is set to alive, the task processing module 520 can determine not to process (e.g., not to continue with processing) the task. As another example, in the event that the vital status of the task is set to dead, the task processing module 520 can determine to process (e.g., continue with processing) the task. In responding to determining to process the task, the vital status of the task can be updated. For example, the vital status of the task can be updated to reflect that the task is being processed by device 500. In some embodiments, the vital status of the task is set to alive. In response to completing processing of the task, the vital status of the task can be updated. For example, task processing module 520 can update the vital status of the task to reflect that the task is not being processed by device 500 (e.g., task processing module 520). In some embodiments, task processing module 520 sets the vital status of the task to dead upon completion of the processing of the task.

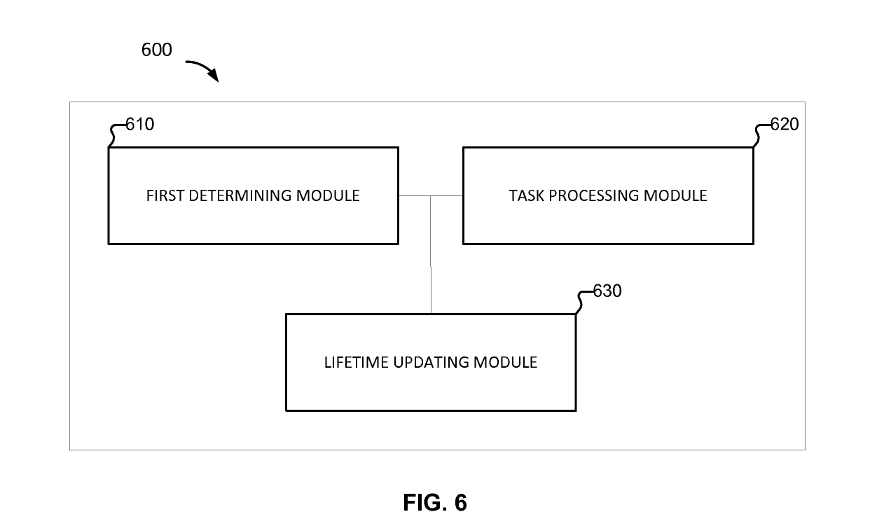

FIG. 6 is a structural block diagram of a device for processing tasks in a distributed system according to various embodiments of the present application.

Referring to FIG. 6, a device 600 for processing tasks is provided. Device 600 can be implemented in a distributed system comprising a plurality of task processors. Device 600 can implement method 200 of FIG. 2.

Device 600 includes a first determining module 610, a task processing module 620, and a lifetime updating module 630.

The first determining module 610 is configured to determine the vital status of a task. The first determining module 610 can determine the vital status of the task after starting a task and before processing the task. In some embodiments, the first determining module 610 retrieves (or acquires) the vital status of the task from a storage device (e.g., a storage server). The vital status is an identifier (e.g., an indicator) that provides an indication of whether a task is being processed by another task processor (or task process). The vital status can be a flag that includes a binary representation of the status of the task. In some embodiments, the vital status includes an alive or a dead indication.

The task processing module 620 is configured to determine whether to process the task according to the vital status of the task. The task processing module 620 determines whether to process the task according to the value of the vital status (e.g., determined by the first determining module 610). For example, in the event that the vital status of the task is set to alive, the task processing module 620 can determine not to process (e.g., not to continue with processing) the task. As another example, in the event that the vital status of the task is set to dead, the task processing module 620 can determine to process (e.g., continue with processing) the task. In responding to determining to process the task, the vital status of the task can be updated. For example, the vital status of the task can be updated to reflect that the task is being processed by device 600. In some embodiments, the vital status of the task is set to alive. In response to completing processing of the task, the vital status of the task can be updated. For example, task processing module 620 can update the vital status of the task to reflect that the task is not being processed by device 600 (e.g., task processing module 620). In some embodiments, task processing module 620 sets the vital status of the task to dead upon completion of the processing of the task.

The lifetime updating module 630 is configured to update the lifetime of the task. The lifetime updating module 630 updates the lifetime of the task after the vital status of the task is updated from being set as dead to being set as alive. The lifetime updating module 630 can update the lifetime of the task at fixed intervals or fixed times.

The lifetime of the task can be stored in association with the task name or task identifier. In some embodiments, the storage device (e.g., the storage server) that stores the task name of the task and the identifier of the vital status associated with the task also saves the lifetime of the task. In some embodiments, the lifetime of the task is updated in real time.

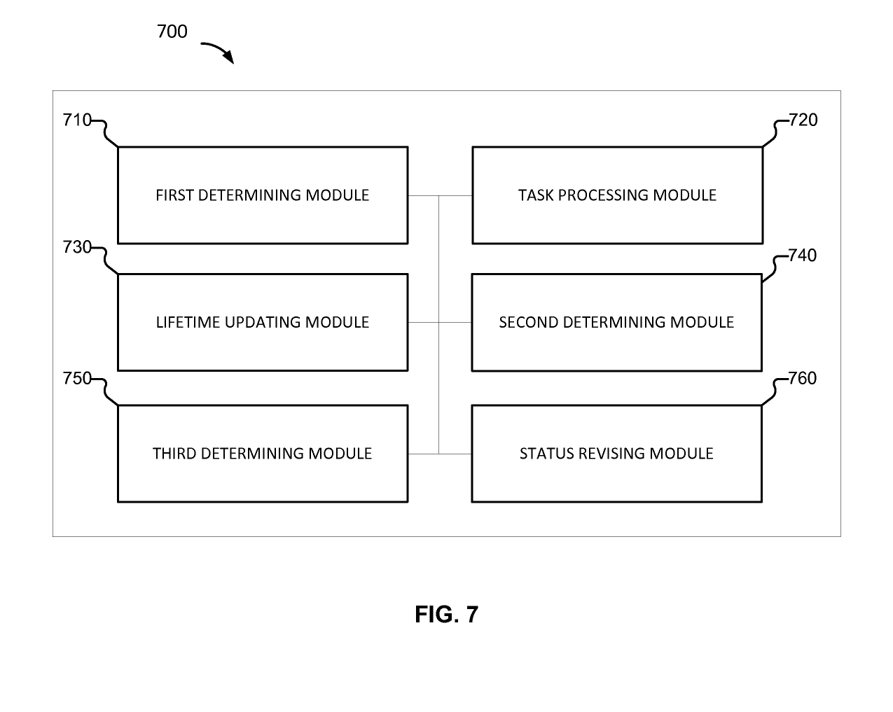

FIG. 7 is a structural block diagram of a device for processing tasks in a distributed system according to various embodiments of the present application.

Referring to FIG. 7, a device 700 for processing tasks is provided. Device 700 can be implemented in a distributed system comprising a plurality of task processors. Device 700 can implement method 200 of FIG. 2, process 300 of FIG. 3, or process 400 of FIG. 4.

Device 700 includes a first determining module 710, a task processing module 720, a lifetime updating module 730, a second determining module 740, a third determining module 750, and a status revising module 760.

The first determining module 710 is configured to determine the vital status of a task. The first determining module 710 can determine the vital status of the task after starting a task and before processing the task. In some embodiments, the first determining module 710 retrieves (or acquires) the vital status of the task from a storage device (e.g., a storage server). The vital status is an identifier (e.g., an indicator) that provides an indication of whether a task is being processed by another task processor (or task process). The vital status can be a flag that includes a binary representation of the status of the task. In some embodiments, the vital status includes an alive or a dead indication.

The task processing module 720 is configured to determine whether to process the task according to the vital status of the task. The task processing module 720 determines whether to process the task according to the value of the vital status (e.g., determined by the first determining module 710). For example, in the event that the vital status of the task is set to alive, the task processing module 720 can determine not to process (e.g., not to continue with processing) the task. As another example, in the event that the vital status of the task is set to dead, the task processing module 720 can determine to process (e.g., continue with processing) the task. In responding to determining to process the task, the vital status of the task can be updated. For example, the vital status of the task can be updated to reflect that the task is being processed by device 700. In some embodiments, the vital status of the task is set to alive. In response to completing processing of the task, the vital status of the task can be updated. For example, task processing module 720 can update the vital status of the task to reflect that the task is not being processed by device 700 (e.g., task processing module 720). In some embodiments, task processing module 720 sets the vital status of the task to dead upon completion of the processing of the task.

The lifetime updating module 730 is configured to update the lifetime of the task. The lifetime updating module 730 updates the lifetime of the task after the vital status of the task is updated from being set as dead to being set as alive. The lifetime updating module 730 can update the lifetime of the task at fixed intervals or fixed times.

The lifetime of the task can be stored in association with the task name or task identifier. In some embodiments, the storage device (e.g., the storage server) that stores the task name of the task and the identifier of the vital status associated with the task also saves the lifetime of the task. In some embodiments, the lifetime of the task is updated in real time.

The second determining module 740 is configured to determine a vital status of the task. For example, the second determining module 740 can determine whether the vital status of the task is alive. The second determining module 740 can determine whether the vital status of the task is alive at fixed times or fixed intervals.

The third determining module 750 is configured to determine whether a length of time that the task has been continually alive is greater than or equal to a threshold time length in the event that the second determining module 740 determines that the vital status of the task is alive. For example, the second determining module 740 can provide an indication of the vital status (or an indication that the vital status of the task is alive) to the third determining module 750.

The status revising module 760 is configured to update (e.g., change) the vital status of the task. In response to receiving an indication from the third determining module 750 that the length of time that the task has been continually set to alive is greater than or equal to the threshold length of time, the status revising module 760 can update the vital status of the task so as to set the vital status to dead. In response to receiving an indication from the third determining module 750 that the length of time that the task has been continually set to alive is not greater than or equal to the threshold length of time, the status revising module 760 can maintain (e.g., not change) the vital status of the task such that the vital status remains set to alive.

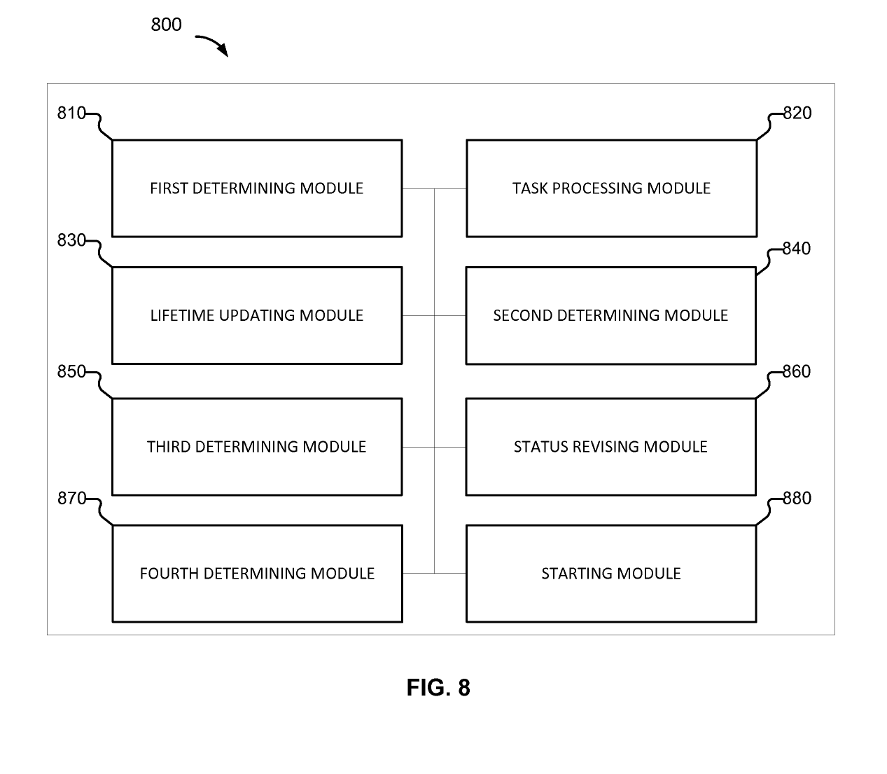

FIG. 8 is a structural block diagram of a device for processing tasks in a distributed system according to various embodiments of the present application.

Referring to FIG. 8, a device 800 for processing tasks is provided. Device 800 can be implemented in a distributed system comprising a plurality of task processors. Device 800 can implement method 200 of FIG. 2, process 300 of FIG. 3, or process 400 of FIG. 4.

Device 800 includes a first determining module 810, a task processing module 820, a lifetime updating module 830, a second determining module 840, a third determining module 850, a status revising module 860, a fourth determining module 870, and a starting module 880.

The first determining module 810 is configured to determine the vital status of a task. The first determining module 810 can determine the vital status of the task after starting a task and before processing the task. In some embodiments, the first determining module 810 retrieves (or acquires) the vital status of the task from a storage device (e.g., a storage server). The vital status is an identifier (e.g., an indicator) that provides an indication of whether a task is being processed by another task processor (or task process). The vital status can be a flag that includes a binary representation of the status of the task. In some embodiments, the vital status includes an alive or a dead indication.

The task processing module 820 is configured to determine whether to process the task according to the vital status of the task. The task processing module 820 determines whether to process the task according to the value of the vital status (e.g., determined by the first determining module 810). For example, in the event that the vital status of the task is set to alive, the task processing module 820 can determine not to process (e.g., not to continue with processing) the task. As another example, in the event that the vital status of the task is set to dead, the task processing module 820 can determine to process (e.g., continue with processing) the task. In responding to determining to process the task, the vital status of the task can be updated. For example, the vital status of the task can be updated to reflect that the task is being processed by device 800. In some embodiments, the vital status of the task is set to alive. In response to completing processing of the task, the vital status of the task can be updated. For example, task processing module 820 can update the vital status of the task to reflect that the task is not being processed by device 800 (e.g., task processing module 820). In some embodiments, task processing module 820 sets the vital status of the task to dead upon completion of the processing of the task.

The lifetime updating module 830 is configured to update the lifetime of the task. The lifetime updating module 830 updates the lifetime of the task after the vital status of the task is updated from being set as dead to being set as alive. The lifetime updating module 830 can update the lifetime of the task at fixed intervals or fixed times.

The lifetime of the task can be stored in association with the task name or task identifier. In some embodiments, the storage device (e.g., the storage server) that stores the task name of the task and the identifier of the vital status associated with the task also saves the lifetime of the task. In some embodiments, the lifetime of the task is updated in real time.

The second determining module 840 is configured to determine a vital status of the task. For example, the second determining module 840 can determine whether the vital status of the task is alive. The second determining module 840 can determine whether the vital status of the task is alive at fixed times or fixed intervals.

The third determining module 850 is configured to determine whether a length of time that the task has been continually alive is greater than or equal to a threshold time length in the event that the second determining module 840 determines that the vital status of the task is alive. For example, the second determining module 840 can provide an indication of the vital status (or an indication that the vital status of the task is alive) to the third determining module 850.

The status revising module 860 is configured to update (e.g., change) the vital status of the task. In response to receiving an indication from the third determining module 850 that the length of time that the task has been continually set to alive is greater than or equal to the threshold length of time, the status revising module 860 can update the vital status of the task so as to set the vital status to dead. In response to receiving an indication from the third determining module 850 that the length of time that the task has been continually set to alive is not greater than or equal to the threshold length of time, the status revising module 860 can maintain (e.g., not change) the vital status of the task such that the vital status remains set to alive.

The fourth determining module 870 is configured to determine whether a preset work cycle time has been reached. The fourth determining module 870 can determine whether the preset work cycle time has been reached before starting the task.

The starting module 880 is configured to determine whether to start (e.g., processing) the task. In the event that the preset work cycle time has been reached, the starting module 880 starts the task. In the event that the preset work cycle time has not been reached, then starting module 880 does not start the task (and the fourth determining module 870 continues to determine whether the preset work cycle time has been reached). For example, the fourth determining module 870 can poll for an indication of an expiration of a timer associated with the preset work cycle time. The fourth determining module 870 can provide an indication of whether the preset work cycle time has been reached to the starting module 880. The starting module 880 can use the indication as a basis for determining whether to start the task.

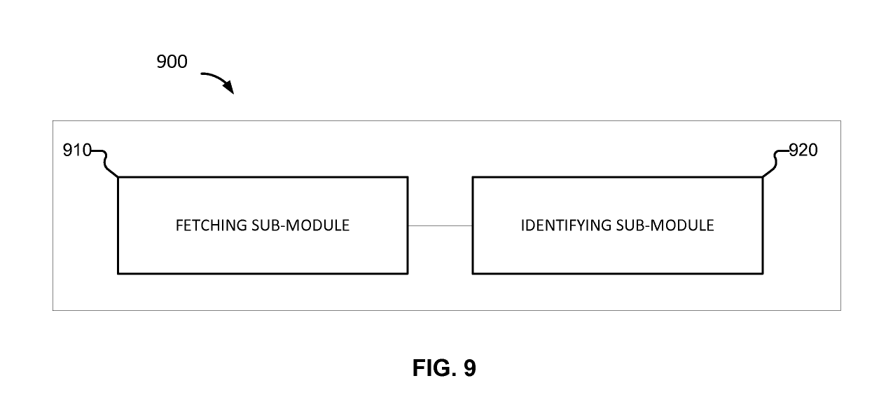

FIG. 9 is a structural block diagram of a first determining module according to various embodiments of the present application.

Referring to FIG. 9, a first determining module 900 is provided. First determining module 900 can implement the first determining module 510 of FIG. 5, first determining module 610 of FIG. 6, first determining module 710 of FIG. 7, and first determining module 810 of FIG. 8.

First determining module 900 can include a fetching sub-module 910 and an identifying sub-module 920.

The fetching sub-module 910 is configured to fetch an identifier that is saved in a storage server and that indicates the vital status of the task.

The identifying sub-module 920 uses the identifier as a basis for determining whether the vital status of the task is alive.

In some embodiments, one unique identifier is saved in the storage server for each type of task. In some embodiments, a task has a unique identifier associated therewith.

The modules described above can be implemented as software components executing on one or more processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present application. The modules may be implemented on a single device or distributed across multiple devices. The functions of the modules may be merged into one another or further split into multiple sub-modules.

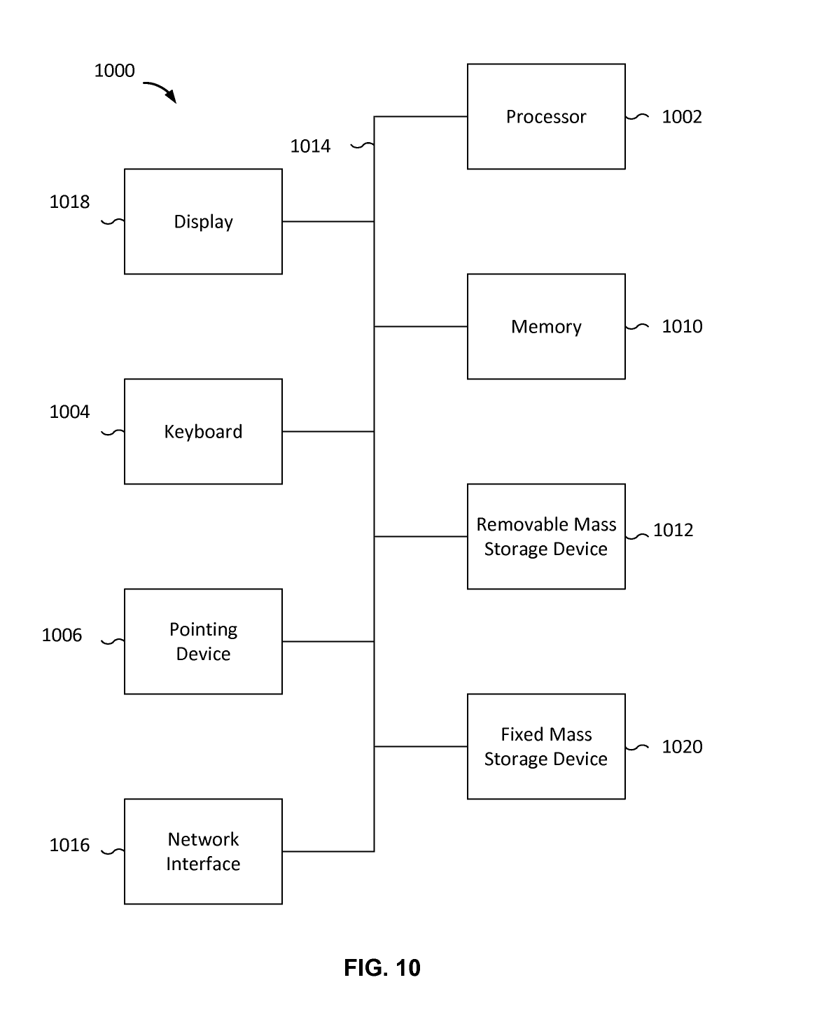

FIG. 10 is a functional diagram of a computer system for processing tasks in a distributed system according to various embodiments of the present application.

Referring to FIG. 10, a computer system 1000 for processing tasks in a distributed system is provided. As will be apparent, other computer system architectures and configurations can be used to implement video calls. Computer system 1000, which includes various subsystems as described below, includes at least one microprocessor subsystem (also referred to as a processor or a central processing unit (CPU)) 1002. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018).

Processor 1002 is coupled bi-directionally with memory 1010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data, and objects used by the processor 1002 to perform its functions (e.g., programmed instructions). For example, memory 1010 can include any suitable computer-readable storage media, described below, depending on whether, for example, data access needs to be bi-directional or uni-directional. For example, processor 1002 can also directly and very rapidly retrieve and store frequently needed data in a cache memory (not shown). The memory can be a non-transitory computer-readable storage medium.

A removable mass storage device 1012 provides additional data storage capacity for the computer system 1000, and is coupled either bi-directionally (read/write) or uni-directionally (read only) to processor 1002. For example, storage 1012 can also include computer-readable media such as magnetic tape, flash memory, PC-CARDS, portable mass storage devices, holographic storage devices, and other storage devices. A fixed mass storage 1020 can also, for example, provide additional data storage capacity. The most common example of mass storage 1020 is a hard disk drive. Mass storage device 1012 and fixed mass storage 1020 generally store additional programming instructions, data, and the like that typically are not in active use by the processor 1002. It will be appreciated that the information retained within mass storage device 1012 and fixed mass storage 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display monitor 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 1000 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 10 is but an example of a computer system suitable for use with the various embodiments disclosed herein. Other computer systems suitable for such use can include additional or fewer subsystems. In addition, bus 1014 is illustrative of any interconnection scheme serving to link the subsystems. Other computer architectures having different configurations of subsystems can also be utilized.

Please note that persons with ordinary skill in the art may understand that all or part of the processes entailed in realizing the above-described embodiment methods can be accomplished by instructing appropriate hardware through computer programs. Said computer programs may be stored in computer-readable storage media. When the programs are executed, they may include the processes of the embodiments of the various methods described above. Said storage media may be magnetic disks, optical disks, read-only memory (ROM), and random-access memory (RAM).

The above-stated are merely embodiments of the present application and do not limit the present application. For persons skilled in the art, the present application may have various modifications and variations. Any modification, equivalent substitution, or improvement made in keeping with the spirit and principles of the present application shall be included within the scope of the claims of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
in response to being triggered to start a task and before processing the task, determining, by a task processor in a distributed system of a plurality of task processors, a vital status of the task;
in the event that the vital status of the task is set to alive, determining not to process the task; and
in the event that the vital status of the task is set to dead:
updating the vital status of the task so as to be set to alive;
processing the task; and
in response to completing the processing of the task, updating the vital status of the task to dead.

2. The method of claim 1, further comprising:
after the updating of the vital status of the task to set the vital status to alive, updating, by the task processor in the distributed system of the plurality of task processors, a lifetime of the task.

3. The method of claim 2, wherein the lifetime is updated at fixed intervals.

4. The method of claim 2, further comprising:
determining, at fixed intervals, whether the vital status of the task is set to alive;
in the event that the vital status of the task is set to alive, determining whether a length of time that the task has been continually set to alive is greater than or equal to a preset threshold time length;
in the event that the length of time that the task has been continually set to alive is greater than or equal to the preset threshold time length, updating the vital status of the task to set the vital status to dead; and
in the event that the length of time that the task has been continually set to alive is not greater than or equal to the preset threshold time length, maintaining the vital status of the task as alive.

5. The method of claim 1, further comprising:
determining whether a preset work cycle time has been reached before starting the task;
in the event that the preset work cycle time has been reached, automatically starting the task; and
in the event that the preset work cycle time has not been reached, polling for an indication that the preset work cycle time has been reached before starting the task.

6. The method of claim 1, further comprising communicating, via a storage server, with the plurality of task processors, and wherein the determining of the vital status of the task comprises:
fetching an identifier that is saved in the storage server and that indicates the vital status of the task; and
determining whether the vital status of the task is alive based on the identifier.

7. The method of claim 6, wherein one unique identifier is saved in the storage server for each type of task.

8. A device, comprising:
at least one processor configured to:
in response to being triggered to start a task and before processing the task, determine a vital status of the task;
in the event that the vital status of the task is set to alive, determine not to process the task; and
in the event that the vital status of the task is set to dead;
update the vital status of the task so as to be set to alive;
process the task; and
in response to completing the processing of the task, update the vital status of the task to dead; and
a memory coupled to the at least one processor and configured to provide the at least one processor with instructions.

9. The device of claim 8, wherein the at least one processor is further configured to:
after the updating of the vital status of the task to set the vital status to alive, update a lifetime of the task.

10. The device of claim 9, wherein the lifetime is updated at fixed intervals.

11. The device of claim 8, wherein the at least one processor is further configured to:
determine, at fixed intervals, whether the vital status of the task is set to alive;
in the event that the vital status of the task is set to alive, determine whether a length of time that the task has been continually set to alive is greater than or equal to a preset threshold time length;
in the event that the length of time that the task has been continually set to alive is greater than or equal to the preset threshold time length, update the vital status of the task so as to set the vital status to dead; and
in the event that the length of time that the task has been continually set to alive is not greater than or equal to the preset threshold time length, maintain the vital status of the task as alive.

12. The device of claim 8, wherein the at least one processor is further configured to:
determine whether a preset work cycle time has been reached before starting the task;
in the event that the preset work cycle time has been reached, automatically start the task; and
in the event that the preset work cycle time has not been reached, poll for an indication that the preset work cycle time has been reached before starting the task.

13. The device of claim 8, wherein the at least one processor is further configured to:
fetch an identifier that is saved in a storage server and that indicates the vital status of the task; and
determine whether the vital status of the task is alive based on the identifier.

14. The device of claim 13, wherein one unique identifier is saved in the storage server for each type of task.

15. A computer program product, the computer program product being embodied in a non-transitory computer readable storage medium and comprising computer instructions for:
in response to being triggered to start a task and before processing the task, determining a vital status of the task;
in the event that the vital status of the task is set to alive, determining not to process the task; and
in the event that the vital status of the task is set to dead;
updating the vital status of the task so as to be set to alive;
processing the task; and
in response to completing the processing of the task, updating the vital status of the task to dead.
